(19) United States
(12) Patent Application Publication
(10) Pub. No.: US 2009/0119504 A1
(43) Pub. Date: May 7, 2009

(54) INTERCEPTING AND SPLIT-TERMINATING AUTHENTICATED COMMUNICATION CONNECTIONS

(75) Inventors: Thomas van Os, San Francisco, CA (US); Puneet Mehra, Berkeley, CA (US); Nitin Gupta, Fremont, CA (US); Kartik Subbana, Fremont, CA (US); Charles Huang, San Francisco, CA (US)

Correspondence Address: PARK, VAUGHAN & FLEMING LLP, 2820 FIFTH STREET, DAVIS, CA, 95618, US

(73) Assignee: Riverbed Technology, Inc., San Francisco, CA (US)

(21) Appl. No.: 12/352,959

(22) Filed: Jan. 13, 2009

Related U.S. Application Data
(63) Continuation-in-part of application No. 11/489,414, filed on Jul. 18, 2006.
(60) Provisional application No. 60/707,804, filed on Aug. 10, 2005.

(51) Int. Cl. H04L 9/00

(52) U.S. Cl. 713/153

(57) ABSTRACT

Systems and methods are provided for enabling optimization of communications within a networked computing environment requiring secure, authenticated client-server communication connections. Optimization is performed by a pair of intermediary network devices installed in a path of communications between the client and the server. A secure, authenticated communication connection between the client and server is split-terminated at a pair of intermediary network devices by intercepting a request from the client for a client-server connection, authenticating the client at the intermediaries, establishing a first secure, authenticated connection to the client, authenticating the client or an intermediary to the server, and establishing a second secure, authenticate connection to the server. Depending on the operative authentication protocol (e.g., NTLM, Kerberos), an intermediary may interface with a domain controller, key distribution center or other entity.

### RELATED APPLICATIONS

The present application is a continuation-in-part of, and hereby claims priority under 35 U.S.C. § 120 to, U.S. patent application Ser. No. 11/489,414, which was filed 18 Jul. 2006 (Atty. Docket No. 021647-001710US) and is incorporated herein by reference. The present application further claims priority under 35 U.S.C. § 119 to U.S. Provisional Patent Application No. 60/707,804, filed 10 Aug. 2005 (Atty. Docket No. 021647-001700US), to which the 11/489,414 parent application also claims priority.

### FIELD

This invention relates to network optimization in general, and in particular to facilitating optimization of network transactions conducted via authenticated and secured communication sessions.

### BACKGROUND

Communications across an untrusted network or other type of communication link are often secured by either or both a public-key cryptographic technique and a symmetric-key cryptographic technique. For example, both types of cryptography may be combined by using a public-key technique to negotiate a symmetric cipher between two entities. The symmetric-key cipher may then be used for bulk data transfer between the entities. Secure Socket Layer (SSL) and Transport Layer Security (TLS) are widely-used examples of secure communication protocols that have this form, as well as IPSec (Internet Protocol Security) when security associations are negotiated using RSA-based (Rivest, Shamir & Adleman) mechanisms for IKE (Internet (or IPsec) Key Exchange).

Besides being encrypted to secure their contents, communication connections may also implement some form of authentication in order to ensure that each communicant is who it purports to be. Authentication schemes are particularly prevalent in client-server computing environments to prevent untrusted entities from spoofing trusted members of the environment.

A transaction accelerator such as that described in U.S. Pat. No. 7,120,666 (McCanne) can offer performance improvement for communications across a wide-area network (WAN), but only when the data being communicated is either intelligible (i.e., the transaction accelerator can interpret at least parts of the protocol) or repeating (i.e., identical data crosses the network in identical format).

The use of secure communication protocols such as SSL and TLS typically frustrates transaction acceleration, because cryptography (by design) renders encrypted data unintelligible and non-repeating. Authentication schemes also tend to frustrate transaction acceleration because such schemes are not designed to permit transaction accelerators to participate in the authentication process. Therefore, network optimization typically is not possible for encrypted communication sessions in which one or both communicants are authenticated.

### SUMMARY

In embodiments of the invention, systems and methods are provided for enabling optimization of communications within a networked computing environment required secure, authenticated client-server communication connections. Optimization is performed by a pair of intermediary network devices installed in a path of communications between the client and the server.

In one embodiment, a secure, authenticated communication connection is split-terminated at a pair of intermediary network devices by intercepting a request for a client-server connection, authenticating the client at the intermediaries and establishing a first secure, authenticated connection to the client, then authenticating the client or an intermediary to the server and establishing a second secure, authenticated connection to the server.

If the authentication protocol is NTLM v1, an intermediary that receives the client's response to the server's authentication challenge may authenticate the client by submitting the client's response and the challenge to a domain controller, and allow the client (or itself) to be authenticated by forwarding the response to the server. The domain controller provides the session key to be used to secure both communication sessions.

If the authentication protocol is NTLM v2, an intermediary may replace the server's authentication challenge with one of its own. The client responds with a multi-part response. The intermediary uses one part of the response to authenticate the client to a domain controller and receive a first session key for the first communication session. The intermediary forwards a second part of the response to the server and also uses it to retrieve a second session key for the second communication session.

In an embodiment of the invention implemented in a computing environment in which the Kerberos authentication protocol is employed, an intermediary intercepts a client-to-server ticket and an authenticator issued toward the server from the client. Besides forwarding the client-to-server ticket to the server, the intermediary requests a secret key of the server from a key distribution center. The secret key is then used to decrypt the client-to-server ticket and retrieve a session key to be used for both communication sessions.

In another embodiment of the invention, SMB (Server Message Block) signing is supported by establishing separate secure, authenticated communication sessions with a client and with a server, and signing messages in either or both sessions, depending on the operating requirements. In this embodiment, an intermediary may implement Kerberos constrained delegation to establish the session with the server and authenticate the client. A different authentication protocol (e.g., NTLM) may be employed to authenticate the client at the intermediary without involving the server.

Yet another embodiment of the invention may be implemented in an environment in which a client establishes multiple, short, successive, authenticated communication (e.g., HTTP) connections with a server. In this embodiment, an intermediary may obtain credentials for authenticating the client to the server (e.g., via Kerberos constrained delegation). When the server rejects a new/subsequent connection request from the client (and issues a challenge requiring the client to be authenticated), the intermediary intercepts the challenge and authenticates the client without having to communicate with the client. Communications across a wide-area network separating the client and server are thereby reduced.

### BRIEF DESCRIPTION OF THE DRAWINGS

FIG. 1 is a block diagram depicting a computing environment in which an embodiment of the present invention may be implemented.

FIG. 2 is a time sequence diagram demonstrating a process for establishing a secure, authenticated, split-terminated communication connection between a client and a server using both NTLM v2 and LM 2, in accordance with an embodiment of the invention.

FIG. 3 is a time sequence diagram demonstrating a process for establishing a secure, authenticated, split-terminated communication connection between a client and a server using the Kerberos authentication protocol, in accordance with an embodiment of the invention.

FIG. 4 is a flowchart illustrating a method of enabling SMB signing while maintaining a secure, authenticated, split-terminated communication connection between a client and a server, in accordance with an embodiment of the present invention.

FIG. 5 is a time sequence diagram demonstrating a process for establishing an authenticated, split-terminated communication connection between a client and a server for multiple successive client-server requests, in accordance with an embodiment of the invention.

FIG. 6 is a block diagram of an intermediary that may be implemented as a client side intermediary or a server side intermediary, in accordance with an embodiment of the invention.

### DETAILED DESCRIPTION OF ILLUSTRATIVE EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In some embodiments of the invention, a method is provided for enabling or facilitating network optimization of secure (i.e., encrypted) communication connections in which one or both communicants are authenticated by a domain controller or other entity. In these embodiments, one or more intermediaries (e.g., a transaction accelerator) are positioned between the endpoints (e.g., a client and a server), and the end-to-end secure, authenticated connection is split-terminated at the intermediary or intermediaries.

These embodiments may be implemented in environments in which authentication is performed according to any of a variety of schemes, including NTLM (NT LAN Manager by Microsof™) version 1 or version 2, LM (LAN Manager) version 1 or version 2, Kerberos. In these environments, following successful authentication, or during the authentication process, the communication connection is normally encrypted using SSL (Secure Sockets Layer), TLS (Transport Layer Security) or some other security protocol.

In particular, embodiments of the invention described herein may be well-suited for implementation within computing environments configured to support client-server applications such as Outlook, utilities such as SMB (Symmetric Message Block) signing and/or sealing, file transfers and/or other actions via CIFS (Common Internet File System), HTTP (HyperText Transport Protocol), etc.

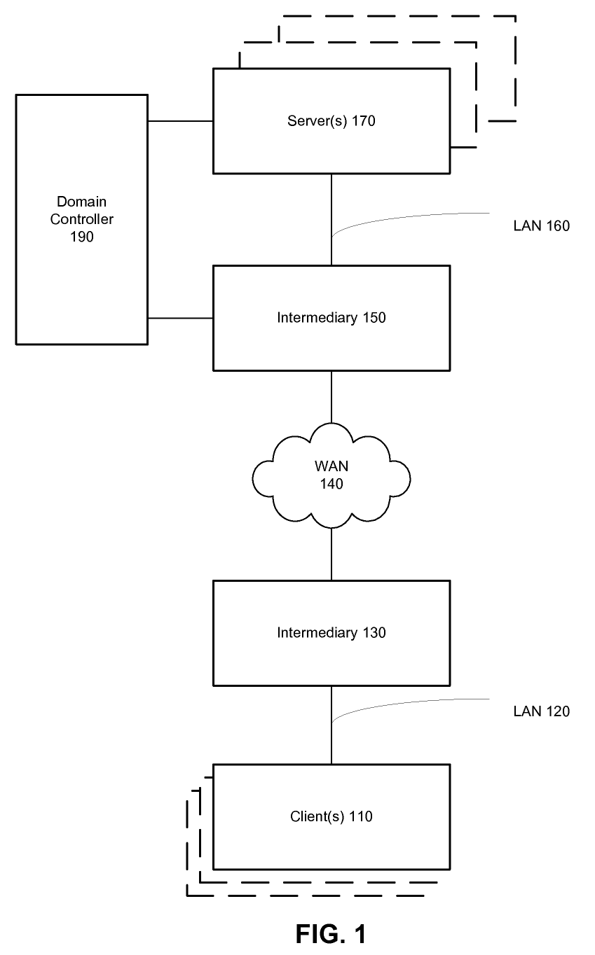

FIG. 1 illustrates one environment in which a pair of network intermediaries is configured to support split-terminated authenticated and secure communication sessions, according to some embodiments of the invention.

In this environment, clients 110 communicate with servers 170 in client-server relationships. Intermediaries 130, 150 are situated in a path or paths of communications between clients 110 and servers 170.

Intermediaries 130, 150 are coupled via WAN (Wide Area Network) 140, while clients 110 are coupled to intermediary 130 via LAN or LANs (Local Area Networks) 120 and servers 170 are coupled to intermediary 150 via LAN or LANs 160. Thus, intermediary 130 is relatively local to clients 110, while intermediary is local to servers 170 (e.g., within the same data center).

Intermediary 130 may be termed a “client side intermediary” (or CSI) and intermediary 150 may be termed a “server side intermediary” (or SSI) to reflect their relative positions within environment 100. Although not shown in FIG. 1, additional client side intermediaries may also cooperate with server side intermediary 150, and/or client side intermediary 130 may cooperate with other server side intermediaries.

Domain controller 190 is coupled to servers 170 and intermediary 150, and may also be coupled to intermediary 130 and/or clients 110. Links to the domain controller may be via LAN, WAN or other classes of media, and communications transiting these links may be encrypted or otherwise secured via suitable protocols.

In the embodiment of FIG. 1, WAN 140 is characterized by relatively high latency and low bandwidth in comparison to LANs 120, 160. In other embodiments of the invention, other types of communication links may be employed. For example, LANs 120 and/or LANs 160 may be WANs, and/or WAN 140 may be a LAN.

In one particular embodiment of the invention, intermediaries 130, 150 are Steelhead™ transaction accelerators from Riverbed® Technology, and are configured to optimize communications and applications (e.g., through compression or acceleration). In other embodiments, the intermediaries may be configured to perform other operations in addition to or instead of optimization, such as routing, caching, etc.

In some embodiments, the intermediaries employ SSL to establish a secure tunnel between themselves over WAN 140 using a symmetric key (with either intermediary acting as client), although in other implementations they may employ a different security scheme. A symmetric key used by the CSI and SSI to encrypt/decrypt messages sent via the tunnel may be represented herein as Kt.

All communication traffic between clients 110 and servers 170 may traverse intermediaries 130, 150 in the illustrated embodiment of the invention. One or both intermediaries may also handle traffic between clients 110 and entities other than servers 170, and/or traffic between servers 170 and other entities. In other embodiments, the clients and servers may also employ other communication paths that skip one or both of the intermediaries.

Each server 170 possesses a valid digital certificate that, among other things, identifies the server and contains the server's public key for use in a PKE (Public Key Encryption) scheme. The server also possesses the corresponding private key. Clients 110 have received, verified and trust a digital certificate of the authority that signed the servers' certificates.

For each client-server pairing, domain controller 190 manages at least one domain that comprises the client and the server, as well as intermediary 150 and/or intermediary 130. Domain controller 190 also serves as a key distribution center (KDC) for the Kerberos network authentication protocol (if Kerberos is used in the environment of FIG. 1), and may participate in other authentication schemes as necessary or appropriate.

Servers 170 and clients 110 may be configured for various applications and/or utilities (e.g., Outlook, SMB signing). It may be noted that no special application, utility or plug-in need be installed on clients 110 in order for them to benefit from embodiments of the invention described herein. In other words, the clients operate the application or utility in the same manner, without requiring any special configuration or reconfiguration.

In one embodiment of the invention, in which a computing environment such as the one depicted in FIG. 1 employs NTLM version 1 (referred to herein as NTLM1) for authentication of a client seeking a connection with a server (e.g., as part of Outlook or some other application), network optimization by intermediaries is enabled as follows. As in FIG. 1, a pair of intermediaries is situated in a path of communications between the client and the server, and the end-to-end communication connection will be split-terminated at the intermediaries.

One intermediary (e.g., server side intermediary 150 of FIG. 1) intercepts the client's initial message requesting a connection, and forwards it to the server. The intermediary likewise intercepts the server's challenge sent in response to the client's request for a connection.

The intermediary further intercepts the client's response to the server challenge. Because the intermediary is a member of the same domain as the client and server, it can then mimic the server by submitting the server challenge and the client's response (i.e., the encrypted LM and MD4 hashes) to the domain controller.

Assuming the domain controller can authenticate the client, it delivers to the intermediary a set of user account info that includes the user session key (USK). The intermediary forwards to the server the client's response after or in parallel with proffering the response to the domain controller, so that the server can also authenticate the client and receive the USK.

Illustratively, the intermediary that performs the above actions may push the USK to its partner intermediary via their secure tunnel. As a result, each intermediary can decrypt the communications it receives (from the client or the server), optimize them and forward them to the other intermediary where they will be re-encrypted and delivered (to the server or the client). The client obtains the USK in the normal manner, in accordance with the NTLM protocol specification.

In a computing environment in which NTLM version 2 (referred to herein as NTLM2) is employed, an intermediary must take additional action to be able to intercept and optimize communications. In some embodiments of the invention, an intermediary (or pair of intermediaries) split-terminates the client-server communication connection and establish different types of sessions with the client and with the server.

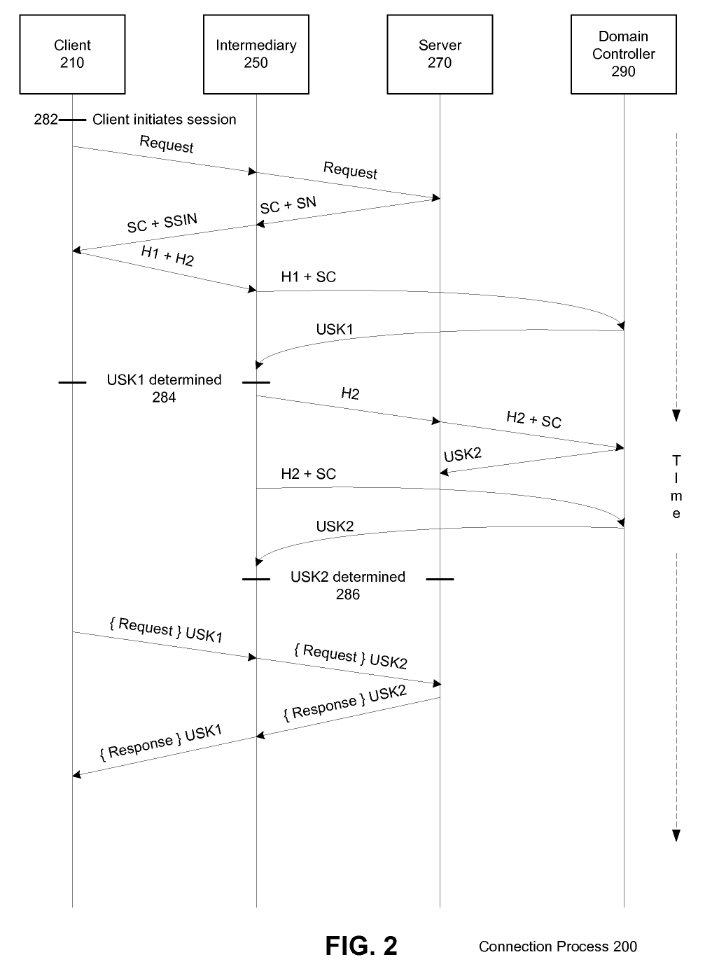

FIG. 2 is a time sequence diagram indicating how a network intermediary establishes a first session with the client using NTLM2, and a second session with the server using LM version 2, according to an embodiment of the invention, which may be implemented in an environment similar to that illustrated in FIG. 1.

At time 282, client 210 issues a connection request toward server 270. The request is intercepted by server side intermediary 250 and forwarded to the server.

The server responds normally, with a server challenge (SC) and the server's name (SN). Although not shown in FIG. 2, the server's domain (SD) may be considered part of SN, or may be envisioned as a separate message component. However, instead of returning the same message to the client, SSI 250 substitutes its name (SSIN) for SN, and sends SC+SSIN, which appears to client 210 as a normal response to its connection request.

If the server's domain SD differs from the SSI's domain SSID, server side intermediary 250 will substitute SSID for SD. Although not shown in FIG. 2, SSID may be considered part of SSIN or as a separate component of the message to the client.

In accordance with the NTLM2 protocol, the client's next message includes two hashes, represented in FIG. 2 as H1 and H2, along with any other required information (e.g., the client challenge). H2 comprises the shorter LMv2 hash response, while H1 comprises the longer NTv2 hash (or Unicode hash) response covering the enhanced client challenge (augmented with a timestamp, domain name, etc). One skilled in the art will recognize that Windows Vista™ by default sends both hashes.

The client's two-part response is intercepted by server side intermediary 250, which initiates NTLM2 authentication of the client by sending H1+SC to domain controller 290, along with any other necessary data (e.g., SSIN). The domain controller returns USK1 (User Session Key 1) to the SSI, and so at time 284 the client and the SSI possess and can use USK1 as the basis for a secure communication session.

To facilitate establishment of a secure communication session with server 270, the SSI forwards H2 to the server, which accepts it as if it came from the client. The server submits H2+SC, and any other necessary data (e.g., SN) to the domain controller, and receives USK2 in return.

Similarly, SSI 250 submits H2+SC to domain controller 290 to receive USK2. Therefore, at time 286, both SSI 250 and server 270 possess and can use USK2 as the basis for a secure communication session. Of course SSI 250 may submit H2 to the domain controller anytime after receiving it, and need not wait until after forwarding it to the server.

Subsequently, a data request from the client will be encrypted with USK1 and received and decrypted by the server side intermediary. The SSI will then re-encrypt the request with USK2 and submit it to the server. The server decrypts the request, then generates and encrypts its response with USK2. The SSI decrypts the response, re-encrypts it with USK1 and delivers it to the client. The client generates USK1 in the normal manner, in accordance with the NTLM protocol specification.

Although FIG. 2 reflects the presence of a single intermediary, in some embodiments of the invention a pair of intermediaries is employed. In these embodiments, and as reflected in FIG. 1, a client side intermediary is located closer to client 210, and cooperates in a secure communication tunnel or session with the server side intermediary.

Thus, the client messages received by SSI 250 as part of the handshaking process of FIG. 2 may actually be intercepted by the CSI and forwarded to the SSI for action, and messages directed to the client may be relayed by the CSI. After derivation of USK1, the SSI may migrate this key to CSI so that it can terminate the secure communication session with the client. As specified previously, communications between the intermediaries may be secured between the intermediaries with Kt or some other key.

In an embodiment of the invention in which a client is authenticated to a server (or an intermediary is authenticated to a server while proxying for the client), after the client (or intermediary) is authenticated, an authentication credential embedded in a subsequent client request submitted to the server may be excised. This may help prevent unnecessary re-authentication of the client (or intermediary) after it has already been authenticated, which may occur in some computing environments in which clients are authenticated using NTLM, Kerberos, password hashing or virtually any other scheme.

For example, the Internet Explorer browser sometimes is not aware that a client has been authenticated in an existing communication session, and subsequently authenticates it again. In this situation an intermediary may realize that the client has already been authenticated and will modify or terminate an extraneous authentication attempt.

In other embodiments of the invention implemented in environments in which clients are authenticated, different measures may be taken to decrease the processing overhead associated with creating an authenticated communication session. For example, when a client initiates a new session with a server to which it has already been authenticated on another (open) connection (e.g., two separate browser sessions with the same server), an intermediary may intervene to reuse the client's credentials from the previous session.

As another example, a round-trip communication across a WAN separating a client from a server may be eliminated with the help of a client side intermediary (CSI). In particular, and as described above, an authentication scheme (e.g., NTLM) may normally entail two round-trips: first to request the session and receive from the server a rejection along with information identify authentication realms that the server supports. In the second round-trip the client would select an authentication realm and finally receive a challenge from the server.

One round-trip can be eliminated if the CSI (situated on the client's side of the WAN) responds to the client's initial request with information identifying one or more authentication realms the server supports. This information may be cached by the CSI after it is first received (e.g., in association with a different client request). In general, the CSI may cache any data previously received from a server and/or modify a client request in a manner that eliminates a round-trip across the WAN or that at least reduces the complexity of an authorization process (e.g., by reducing the number of steps), without compromising network security.

Other embodiments of the invention allow an intermediary or pair of intermediaries to participate in an end-to-end authenticated communication connection in which the Kerberos protocol is used for mutual authentication

Kerberos is used as the default authentication method in some versions of Microsoft Windows™. According to the Kerberos protocol, a key distribution center (KDC) (e.g., a domain controller or other trusted third party) and each entity that cooperates with the KDC share a secret key known only to them, for generating session keys to secure their communications. The shared key changes over time.

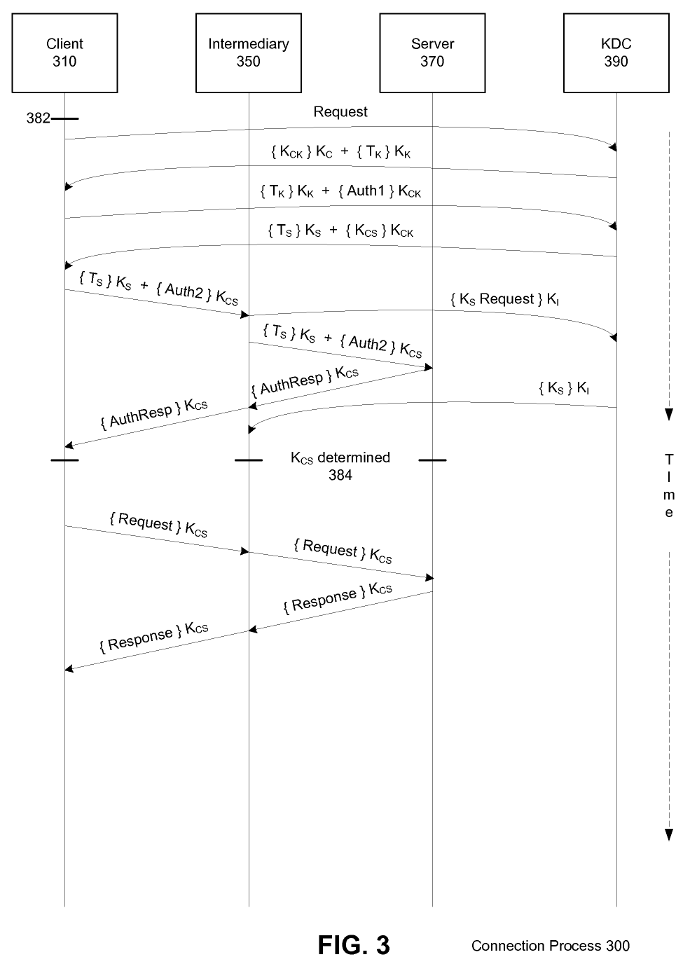

FIG. 3 is a time sequence diagram demonstrating how an intermediary may insert itself into a client-server communication connection in which Kerberos authentication is applied, according to an embodiment of the invention.

In FIG. 3, Kerberos tickets are represented by “T” and keys are represented by “K”, with appropriate identifiers following these symbols. For example, secret keys of a client, an intermediary, a server and a KDC may be represented as K_{C}, K_{I}, K_{S} and K_{K} respectively. Shared keys may include K_{CK} (shared by client and KDC) and K_{CS} (shared by client and server). Similarly, T_{K} and T_{S} represent tickets destined for the KDC and a server, respectively.

Encrypted data and messages are placed in brackets, followed by a representation of the symmetric key used encrypt/decrypt the data or message. Thus, a message comprising “{T_{S}} K_{S}” indicates that a ticket intended for a server is encrypted with a key known to that server.

In the illustrated embodiment of the invention, at time 382 client 310 issues a cleartext request to Kerberos key distribution center 390. In conjunction with this request, the client generates secret key K_{C} from the active user's password.

KDC 390 receives the request and checks a registry or database to ensure the client is known. If so, the KDC responds by sending (a) client-KDC session key K_{CK} for securing communications between the client and the KDC (encrypted with K_{C}) and (b) Kerberos ticket-granting ticket T_{K}, encrypted with the KDC's secret key K_{K} (which is not known to the client).

Client 310 decrypts (a) to retrieve K_{CK}, and can now authenticate itself to the KDC. The client then sends (b) back to the KDC along with authenticator Auth1, encrypted with K_{CK}, plus an identifier of the service it is requesting (not shown in FIG. 3).

KDC 390 retrieves and decrypts (b) and Auth1 to ensure the client's request is still valid, and responds with Kerberos client-to-server ticket T_{S} (encrypted with the service's or server's secret key K_{S}) and a client-server session key K_{CS} for use by the client and server (encrypted with the client-KDC session key.

The client now issues a service request toward server 370, which is intercepted by intermediary 350. The service request comprises server (or service) ticket T_{S} (encrypted by the server's or service's secret key) and a new authenticator Auth2 encrypted with the client-server session key K_{CS}.

Besides forwarding the service request to server 370, intermediary 350 also issues a request to KDC 390 for a copy of the server's private key K_{S}. With K_{S}, the intermediary can extract ticket T_{S} and learn client-server key K_{CS}.

Normally, key K_{S} is only known to the server and the KDC, but because the intermediary is a member of the same domain as the server and KDC, it can issue this request. In some operating environments, the intermediary's trusted nature allows it to obtain private keys for any or all servers within a particular domain, whether or not it is a member of those domains. In other environments, intermediary 350 may need to act as (or to simulate acting as) a domain controller in order to obtain this information.

The intermediary's request for the server's private key is encrypted with the intermediary's private key K_{I}, as is the KDC's response. The sequencing demonstrated in FIG. 3 is merely illustrative; the intermediary may submit its request for K_{S} any time after it knows the key will be needed, and may receive the key any time after its request.

When the server receives the relayed T_{S} and Auth2, it decrypts the ticket to extract the encapsulated K_{CS}, which can then be used to decrypt the authenticator. Server 370 then returns an authentication response as specified by the Kerberos protocol, which the intermediary receives and forwards to the client. In an alternative embodiment of the invention, intermediary 350 may generate its own authentication response and send it to the client. Thus, at time 384, all interested parties possess the client-server session key.

Subsequently, client data requests are encrypted with K_{CS} and forwarded via intermediary 350 (for optimization) to server 370. The server similarly uses K_{CS} to encrypt its response which is also forwarded via the intermediary (for optimization) to the client.

It should be noted that the intermediary's acquisition of various encryption/decryption keys need not be performed in the same time frame described immediately above. For example, it may assemble a collection of keys for specific servers with which it will communicate before any authentication attempt is initiated with those servers. Yet further, it may obtain one or more keys without interacting with a KDC. For example, it may receive them via a system administrator or an automated entity that recognizes the intermediary's trusted status.

As in the NTLM2 authentication process described in conjunction with FIG. 2, in the embodiment of the invention described in conjunction with FIG. 3 intermediary 350 may be replaced with a pair of intermediaries (as shown in FIG. 1). In such an implementation, a server-side intermediary may perform most of the intermediary's role, and migrate key K_{CS} to the client-side intermediary after it is learned.

In some embodiments of the invention, an intermediary's scheme for operating within the Kerberos authentication protocol may be implemented along with a scheme described previously for operating within the NTLM1 and/or NTLM2 protocols.

In an embodiment of the invention implemented in a computing environment in which a suitable method of authentication is employed, an intermediary may intervene to change the manner or order in which authentication options are presented to a client, or take some other action to affect which authentication scheme is activated or how authentication proceeds.

For example, an intermediary may force NTLM authentication in place of Kerberos. Because Kerberos requires multiple exchanges with a KDC, which is usually located remote from clients, such as across a WAN, forcing the use of NTLM instead of Kerberos allows the number of round-trips across the WAN to be reduced.

In general, some authentication schemes are more efficient than others (e.g., in terms of how many round-trips are required across a WAN). However, a client may not be configured to consider efficiency when initiating or selecting a particular authentication scheme. Instead, it may be programmed to automatically take the first option offered by a server, the most secure scheme, etc.

By changing the order in which authentication schemes are presented to a client for selection, or by removing one or more options (and thereby preventing the client from selecting them), an intermediary may be able to make communications more efficient. These actions may be taken even if both the client and server support all the authentication schemes originally enumerated.

Another embodiment of the invention may be implemented in an environment in which a client and a server can cooperate only through a limited number of authentication schemes. If the scheme or schemes supported by both entities are inefficient in some regard (e.g., number of WAN round-trips), an intermediary may intervene to translate between a scheme supported by the client and a scheme supported by the server. For example, and as described immediately below in the context of SMB signing, when the client and server do not both support one efficient authentication scheme, an intermediary may force the use of one scheme with the client (e.g., NTLM) and a different scheme with the server (e.g., Kerberos).

SMB (Server Message Block) signing is a security mechanism used to ensure the integrity of a communication. When both communicants (e.g., a client and a server) employ SMB signing, their communications are augmented with digital signatures that allow the recipient to verify the originator. In particular, SMB signing involves augmenting an SMB packet with a digital signature generated by hashing the data to be transmitted with a session key established for the communication connection.

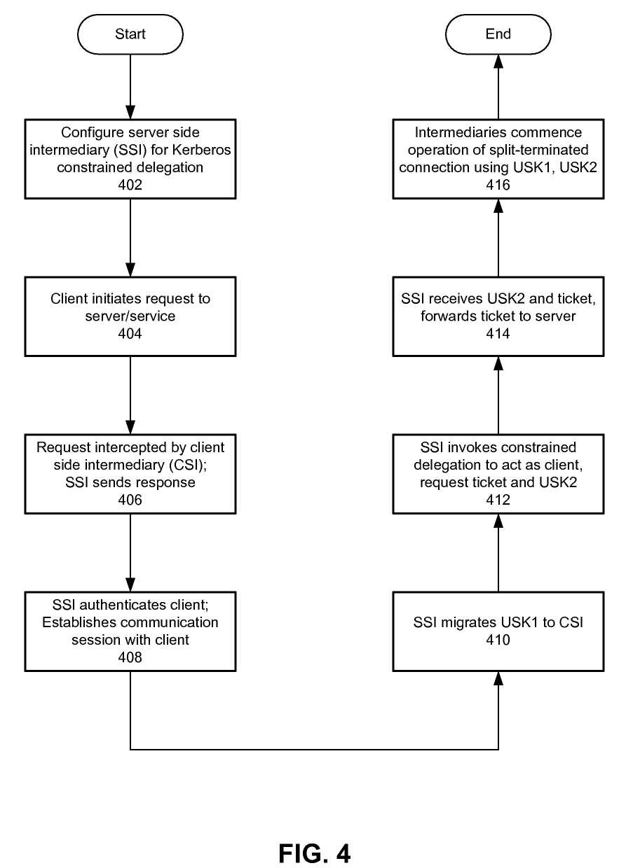

FIG. 4 is a flowchart illustrating a method of establishing a split-terminated secure end-to-end communication connection between a client and a server that requires SMB signing, according to an embodiment of the invention. In such an environment, the server will not accept communications that do not include a digital signature corresponding to the client with which it is communicating. The client may or may not also require SMB signing.

In this embodiment, a pair of intermediaries is able to operate within the communication stream between the client and the server, to optimize or otherwise manipulate the client-server communications. As described in previous embodiments, the intermediaries establish a first communication session with a client (which allows the client's identify to be verified) and a second communication session with the server (while acting as the client). Either or both of the sessions may be authenticated and/or secured via encryption.

In operation 402, a server side intermediary is configured to take advantage of the Kerberos constrained delegation mode of operation. In particular, the SSI, as a trusted member of the computing domain, is permitted to request from the KDC a ticket issued in the name of any (or specified) clients, for use with any (or specified) servers and/or services.

In this embodiment of the invention, the server side intermediary is a server member of the same domain as the client and the server. The intermediary may also be configured with one or more digital certificates issued in a name matching the name of the server (exactly or with wildcards) to which the client submitted the connection request. Because the SSI is a trusted member of the computing environment, the risk assumed by allowing the intermediary to proxy for the server to establish a split-terminated communication connection is very low.

In operation 404, a client initiates a connection request toward the server. Depending on the environment, the client may propose or initiate any of a variety of authentication schemes, such as NTLM1, NTLM2, LMv2, Kerberos, etc.

In operation 406, a client side intermediary intercepts the connection request and forwards it to the server side intermediary, which responds appropriately depending on an applicable authentication protocol. For example, if NTLM is in effect, the server side intermediary generates a suitable challenge and sends it to the client via the client side intermediary.

In operation 408, the client and server side intermediary finalize creation of a secure, authenticated communication session. Thus, for NTLM the client may respond to the intermediary's challenge, and the SSI may submit the response and its challenge to a domain controller or other entity for authentication of the client. From the preceding descriptions of other embodiments of the invention, one will appreciate how an authenticated communication connection may be established between the client and an intermediary using any of various authentication protocols.

After operation 408, the server side intermediary possesses USK1 for securing communications between the client and the intermediary, and for generating digital signatures for SMB signing as necessary, and has verified the client's identity.

It may be noted that USK1 refers to the final user session key that will actually be used for message signing and/or encryption. As with other embodiments of the invention described herein, depending on the manner in which a communication session is negotiated, a preliminary key may first be obtained, which will be used to derive the final, operative, USK. This may be seen, for example, when the “Negotiate Key Exchange” flag is negotiated between a client and server during an NTLM authentication process.

In operation 410, the server side intermediary migrates USK1 to the client side intermediary. Thereafter, the CSI can handle communications to and from the client, including performing SMB signing by applying USK1 to generate a suitable digital signature.

In operation 412, the SSI contacts a Kerberos KDC (or domain controller or other appropriate entity) and invokes its constrained delegation authorization to request a client-to-server ticket issued in the name of the client (user) with which the intermediary just established a communication session. The SSI identifies to the KDC the client (user) and the server/service to which the client's original request was directed.

In operation 414, the SSI receives the client-to-server ticket and USK2—the client-server session key that will be used for SMB signing of communications between the intermediary and the server.

In operation 416, the SSI commences relaying communications between the client and the server, while signing all the communications sent to the server.

More particularly, the intermediary receives and decrypts communications from the client using USK1, then re-encrypts and signs them using USK2 before submitting them to the server. In these communications, the SSI may appear to the server as the client. The reverse procedure is applied for communications in the opposite direction.

Some embodiments of the invention described above involve inherently relatively long-lived (e.g., TCP or Transport Control Protocol) connections. In those embodiments, after authentication has been performed and a connection has been established, the authentication may persist for the duration of the connection—even if it lasts hours or days. In comparison, the overhead incurred by performing authentication, even with a pair of intermediaries, is not significant.

Other embodiments of the invention may be implemented to enable network optimization where authentication is required even for communication connections of significantly shorter duration (e.g., HTTP connections). For example, per-object authentication performed for a web service request generally lasts only as long as needed to satisfy a single transaction (e.g., to retrieve one object within a requested web page). Authentication must be repeated for each transaction. If multiple transactions are required (e.g., to retrieve an entire web page), performing authentication while accommodating a pair of intermediaries for network optimization could result in significant overhead.

The type of authentication employed may exacerbate the situation. For example, if Kerberos authentication is required, every time a client commences a new transaction it may have to exchange communications with a KDC to obtain a ticket, and these communications will likely have to traverse a wide-area network. The combined latencies encountered during the processing of multiple transactions could degrade an end user's experience.

Therefore, in some embodiments of the invention, an intermediary positioned between a client and one or more servers engaged in HTTP communications (or other short-lived communications that may require authentication) satisfies much of the client's authentication requirements with the server(s). In particular, the intermediary may intercept and satisfy a server's authentication request without involving the client. In one implementation, the intermediary may be configured to invoke the Kerberos constrained delegation mode of operation to allow it to proxy for multiple clients and multiple servers/services.

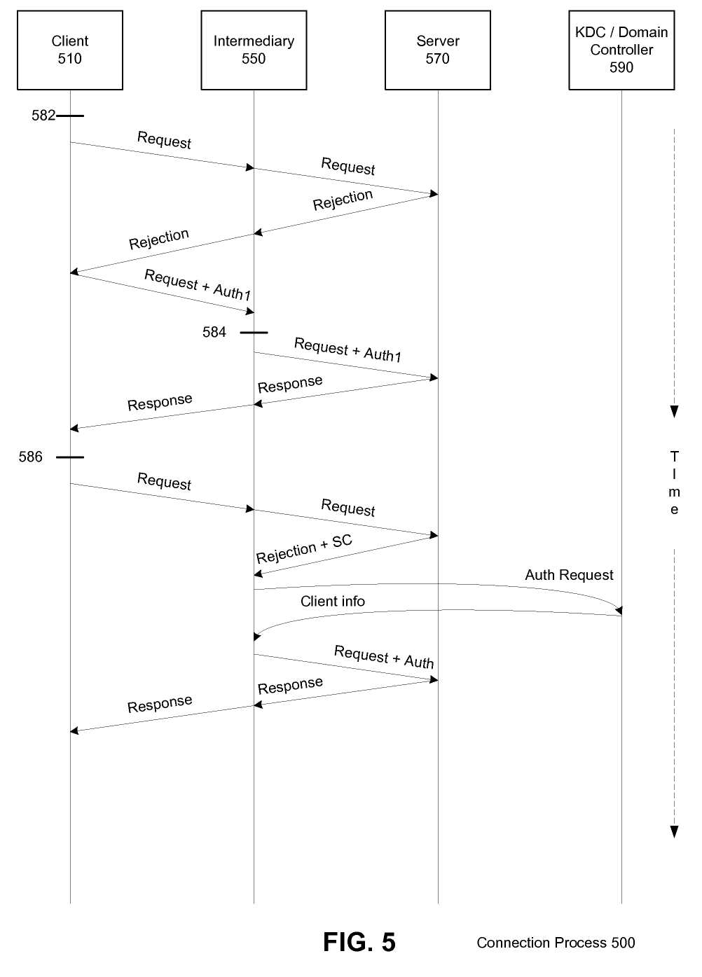

FIG. 5 is a time sequence diagram demonstrating a method of employing an intermediary to satisfy authentication requirements for frequent, short-lived (e.g., HTTP) connections, according to one embodiment of the invention. Although the diagram reflects the use of a single intermediary, as described above, in other embodiments a pair of intermediaries may cooperate to perform the indicated functions as well as optimize communications that traverse a wide-area network.

At time 582, client 510 issues a first request for a temporary connection toward server 570. Illustratively, the request may comprise an HTTP Get. The request is intercepted by intermediary 550, which relays it to the server. The intermediary may note which server/service is invoked, the client's identity and/or other information regarding the request.

Because the server requires clients be authenticated before it will serve requested data, and because the request lacks an authentication header, it returns a rejection (e.g., HTTP message 401). Intermediary 550 forwards the rejection to the client. Client 510 reissues the request, this time with an authentication header Auth1.

Although not shown in FIG. 5, Auth1 may be derived in accordance with the Kerberos authentication protocol. In particular, the client may communicate with KDC/Domain Controller 590 to obtain an appropriate ticket, and use that ticket to form Auth1.

Upon receipt of Auth1, at time 584 the intermediary authenticates the user. Illustratively, if the authentication method indicated by Auth1 is NTLM1, it may forward the client's hash response to KDC/Domain Controller 590.

Regardless of the form of Auth1 (e.g., NTLM1, NTLM2, Kerberos), the replacement request and Auth1 are forwarded to server 570. The server now authenticates the client/user and returns a response comprising the requested data, which the intermediary forwards to the client.

Subsequently, after time 586, client 510 issues a request for another object, which intermediary 550 relays to server 570. Because the server applies a form of per-object authentication and this subsequent client request lacks an authentication header, the server rejects the request.

Because the intermediary has already authenticated the client (and can therefore trust that the client is who it purports to be), it will independently respond to the server's request for authentication without involving the client (and thereby save a round-trip across the wide-area network coupling the client to the server).

In one implementation of this embodiment of the invention, intermediary 550 invokes the Kerberos constrained delegation mode of operation by requesting from KDC/DC 590 a ticket for the server/service in the name of the client/user. In other implementations the intermediary may seek other information with which it can authenticate the user to the server—such as by retrieving the client's private key from KDC/DC 590 and using it to generate a hash to send to the server.

The intermediary resends the client request, along with the necessary authentication header Auth to the server. The server authenticates what it thinks is the client, and returns the requested data.

Thus, in an embodiment of the invention reflected in FIG. 5, one authentication scheme (e.g., NTLM) may be used to authenticate a client at an intermediary, while a different scheme (e.g., Kerberos) may be used by the intermediary to authenticate the client (e.g., the intermediary acting as the client) to the server.

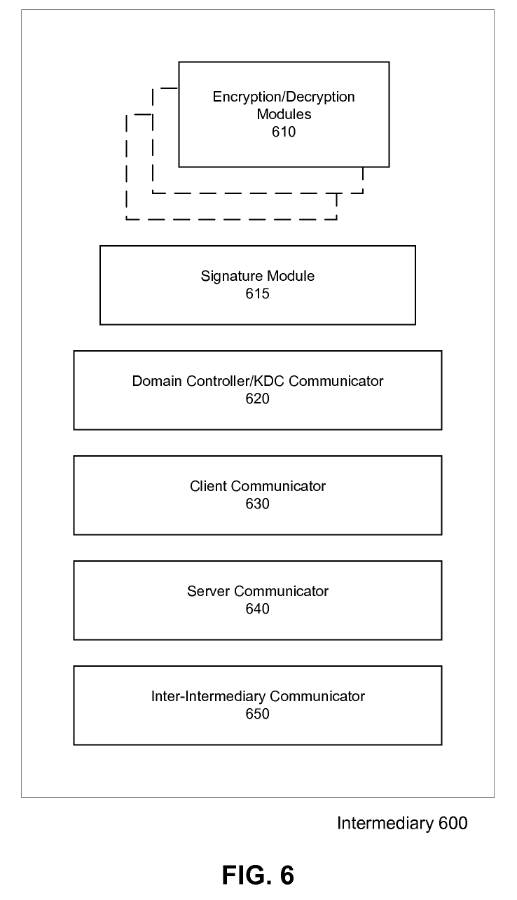

FIG. 6 is a block diagram of an intermediary that may be employed to enable optimization of communications within a secure, authenticated communication environment described above.

Intermediary 200 includes any number of encryption/decryption modules 610 for encrypting and/or decrypting communications. Different modules may perform different types of encryption/decryption schemes, may use different keys, may operate on communications sent to or received from different entities (e.g., a client, a server, another intermediary), or may be distinguished in some other manner. Although not shown in FIG. 6, a key repository may be maintained on intermediary 600 for use by modules 610.

In an embodiment of the invention in which intermediary 600 supports SMB signing, signature module 615 is responsible for signing outgoing communications and verifying the signature of incoming SMB-signed communications.

Domain controller/KDC communicator 620 is configured to communicate with a domain controller, KDC or other entity involved in authenticating clients and/or servers. Communicator 620 may therefore also be configured to join the intermediary to a domain, retrieve a user session key (USK) or other key (e.g., a server's private key for use in Kerberos authentication), etc. In general, it may be configured to handle all authentication-related and/or domain-related communications.

More particularly, communicator 620 may implement samba and/or other software or utilities to facilitate joining a domain, supporting NTLM authentication requests and/or performing other tasks. For example, the winbindd daemon may be invoked via an LGPL (Lesser General Public License) C interface, possibly via a C++ wrapper, to submit a client's authentication response to a domain controller.

Client communicator 630 is configured to handle communications with a client, such as to facilitate establishment of a secure, authenticated communication session. Illustratively, if intermediary 600 is implemented strictly as a server side intermediary, module 630 may be omitted.

Server communicator 640 is configured to handle communications with a server, such as to facilitate establishment of a secure, authenticated communication session. Illustratively, if intermediary 600 is implemented strictly as a client side intermediary, module 640 may be omitted.

Inter-intermediary communicator 650 is configured to manage communications between intermediary 600 and another communicator. This communicator may be responsible, for example, for migrating a session key from an SSI to a CSI.

Any of the communicators may invoke an encryption/decryption module 610, and/or other modules, depending on the nature of their communications. Communicator modules may employ DCE/RPC (Distributed Computing Environment/Remote Procedure Calls) or some other RPC system to communicate with other entities.

The configuration illustrated in FIG. 6 and discussed here is merely illustrative and is not meant to be limiting. Depending on the role of the intermediary (e.g., CSI, SSI) and/or the computing environment in which it is deployed (e.g., which authentication protocols are in use, which applications are executed), some of the illustrated components may be omitted. In other embodiments of the invention, the functionality described herein may be distributed among the same and/or other components in a different manner.

The environment in which a present embodiment of the invention is executed may incorporate a general-purpose computer or a special-purpose device such as a hand-held computer. Details of such devices (e.g., processor, memory, data storage, display) may be omitted for the sake of clarity.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules may include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. A method of establishing a split-terminated authenticated communication connection between a client computing device and a server computing device, the method comprising:
intercepting a request for a communication connection from the client, at a first intermediary situated in a path of communication between the client and the server;
establishing a first authenticated communication session between the client and the first intermediary; and
establishing a second authenticated communication session between the first intermediary and the server.

2. The method of claim 1, wherein:
said establishing a first authenticated communication session comprises authenticating the client to the first intermediary with a first authentication protocol; and
said establishing a second authenticated communication session comprises authenticating the first intermediary to the server with a second authentication protocol different from the first authentication protocol.

3. The method of claim 1, wherein said establishing a second authenticated communication session comprises authenticating the first intermediary to the server using an identity of the client.

4. The method of claim 1, wherein said establishing a first authenticated communication session comprises:
forwarding the request for the communication connection to the server;
receiving from the server an authentication challenge;
forwarding the authentication challenge to the client; and
receiving from the client a response to the authentication challenge.

5. The method of claim 4, wherein said establishing a first authenticated communication session further comprises forwarding the challenge and the response to a domain controller configured to authenticate the client, the method further comprising:
receiving from the domain controller a session key for the first communication session.

6. The method of claim 5, wherein said establishing a second authenticated communication session comprises:
forwarding the response to the server; and
using the session key for the second communication session.

7. The method of claim 5, further comprising:
forwarding the session key from the first intermediary to a second intermediary situated in a path of communication between the client and the first intermediary;
wherein the first intermediary and the second intermediary cooperate to optimize communications between the client and the server.

8. The method of claim 7, further comprising:
at the second intermediary:
receiving a message directed to the server from the client;
decrypting the message with the session key;
encrypting the message with an intermediary key known only to the first intermediary and the second intermediary; and
forwarding the message to the first intermediary; and
at the first intermediary:
decrypting the message with the intermediary key;
encrypting the message with the session key; and
forwarding the message to the server.

9. The method of claim 8, further comprising:
at the first intermediary:
receiving a response message directed to the client from the server;
decrypting the response message with the session key;
encrypting the response message with the intermediary key; and
forwarding the response message to the second intermediary; and
at the second intermediary:
decrypting the response message with the intermediary key;
encrypting the response message with the session key; and
forwarding the response message to the client.

10. The method of claim 1, wherein said establishing a first authenticated communication session comprises:
forwarding the request for the communication connection to the server;
receiving from the server a first authentication challenge;
sending to the client a second authentication challenge different than the first authentication challenge; and
receiving from the client a response to the second authentication challenge.

11. The method of claim 10, wherein said establishing a first authenticated communication session further comprises forwarding the second authentication challenge and a first subset of the response to a domain controller configured to authenticate the client, the method further comprising:
receiving from the domain controller a first session key for the first communication session.

12. The method of claim 11, wherein said establishing a second authenticated communication session comprises:
forwarding a second subset of the response to the server;
forwarding the first authentication challenge and the second subset of the response to the domain controller;
receiving from the domain controller a second session key for the second communication session.

13. The method of claim 11, further comprising:
forwarding the first session key from the first intermediary to a second intermediary situated in a path of communication between the client and the first intermediary;
wherein the first intermediary and the second intermediary cooperate to optimize communications between the client and the server.

14. The method of claim 13, further comprising:
at the second intermediary:
receiving a message directed to the server from the client;
decrypting the message with the first session key;
encrypting the message with an intermediary key known only to the first intermediary and the second intermediary; and
forwarding the message to the first intermediary; and
at the first intermediary:
decrypting the message with the intermediary key;
encrypting the message with the second session key; and
forwarding the message to the server.

15. The method of claim 14, further comprising:
at the first intermediary:
receiving a response message directed to the client from the server;
decrypting the response message with the second session key;
encrypting the response message with the intermediary key; and
forwarding the response message to the second intermediary; and
at the second intermediary:
decrypting the response message with the intermediary key;
encrypting the response message with the first session key; and
forwarding the response message to the client.

16. The method of claim 1, further comprising:
detecting an attempt to re-authenticate the first authenticated communication session; and
suppressing the attempt to re-authenticate.

17. The method of claim 1, wherein said establishing a first authenticated communication session comprises:
reusing authentication credentials of the client from a previously established authenticated communication session.

18. The method of claim 1, wherein said establishing a second authenticated communication session comprises:
reusing authentication credentials of the client from a previously established authenticated communication session.

19. The method of claim 1, further comprising:
caching data received from the server during establishment of a previous authenticated communication session.

20. The method of claim 19, wherein said establishing a first authenticated communication session comprises:
at a second intermediary situated in a path of communication between the client and the first intermediary, using the cached data to respond to the request for a communication connection.

21. The method of claim 1, further comprising:
intercepting a message from the server, directed toward a target client, wherein the message comprises one or more authentication options; and
modifying the authentication options before forwarding the message to the target client.

22. The method of claim 21, wherein said modifying comprises one or more of:
deleting an option; and
changing an order of the options.

23. The method of claim 21, wherein the authentication options comprise identifiers of one or more authentication schemes.

24. A computer-readable medium storing instructions that, when executed by a computer, cause the computer to perform a method of establishing a split-terminated authenticated communication connection between a client computing device and a server computing device, the method comprising:
intercepting a request for a communication connection from the client, at a first intermediary situated in a path of communication between the client and the server;
establishing a first authenticated communication session between the client and the first intermediary; and
establishing a second authenticated communication session between the first intermediary and the server.

25. A method of establishing a split-terminated authenticated communication connection between a client computing device and a server computing device, the method comprising:
at a first intermediary situated in a path of communication between the client and the server, intercepting a client-to-server ticket and an authenticator issued toward the server from the client;
forwarding the client-to-server ticket to the server;
requesting from a key distribution entity a secret key of the server;
decrypting the client-to-server ticket with the secret key to retrieve a session key;
establishing a first authenticated communication session between the client and the first intermediary; and
establishing a second authenticated communication session between the first intermediary and the server.

26. The method of claim 25, wherein said requesting from a key distribution entity a secret key of the server comprises:
replicating at the first intermediary at least a portion of a registry of keys of the key distribution entity.

27. The method of claim 25, wherein said establishing a first authenticated communication session between the client and the first intermediary comprises:
decrypting the authenticator with the session key; and
sending toward the client an authentication response.

28. The method of claim 25, wherein said establishing a first authenticated communication session between the client and the first intermediary comprises:
receiving from the server an authentication response configured to indicate that the server has authenticated the client; and
forwarding the authentication response toward the client.

29. The method of claim 25, further comprising:
forwarding the session key from the first intermediary to a second intermediary situated in a path of communication between the client and the first intermediary;
wherein the first intermediary and the second intermediary cooperate to optimize communications between the client and the server.

30. The method of claim 29, further comprising:
at the second intermediary:
receiving a message directed to the server from the client;
decrypting the message with the session key;
encrypting the message with an intermediary key known only to the first intermediary and the second intermediary and not the client or the server; and
forwarding the message to the first intermediary; and
at the first intermediary:
decrypting the message with the intermediary key;
encrypting the message with the session key; and
forwarding the message to the server.

31. The method of claim 30, further comprising:
at the first intermediary:
receiving a response message directed to the client from the server;
decrypting the response message with the session key;
encrypting the response message with the intermediary key; and
forwarding the response message to the second intermediary; and
at the second intermediary:
decrypting the response message with the intermediary key;
encrypting the response message with the session key; and
forwarding the response message to the client.

32. A method of establishing a split-terminated authenticated communication connection between a client computing device and a server computing device, the method comprising:
intercepting a request for a communication connection from the client, at a first intermediary situated in a path of communication between the client and the server;
establishing a first authenticated communication session between the client and the first intermediary using a first authentication protocol; and
establishing a second authenticated communication session between the first intermediary and the server using a second authentication protocol different from the first authentication protocol; and
performing server message block signing on all communications directed to the server during the second authenticated communication session.

33. The method of claim 32, wherein said establishing a first authenticated communication session between the client and the first intermediary comprises:
issuing an authentication challenge to the client;
receiving from the client a response to the authentication challenge;
submitting the challenge and the response to a domain controller; and
receiving from the domain controller a first session key for the first communication session;
wherein the request for a communication connection is not forwarded to the server.

34. The method of claim 33, further comprising, prior to said establishing a second authenticated communication session between the first intermediary and the server:
configuring the first intermediary to perform constrained Kerberos delegation to enable the first intermediary to obtain a client-to-server ticket in the name of the client.

35. The method of claim 34, wherein said establishing a second authenticated communication session between the first intermediary and the server comprises:
soliciting from a key distribution entity a client-to-server ticket issued in the name of the client;
receiving from the key distribution entity the client-to-server ticket and a second session key for the second communication session; and
forwarding the client-to-server ticket to the server to enable the server to authenticate the first intermediary as a proxy for the client.

36. The method of claim 35, further comprising:
forwarding the first session key from the first intermediary to a second intermediary situated in a path of communication between the client and the first intermediary;
wherein the first intermediary and the second intermediary cooperate to optimize communications between the client and the server.

37. The method of claim 36, further comprising:
at the second intermediary:
receiving a message directed to the server from the client;
decrypting the message with the first session key;
encrypting the message with an intermediary key known only to the first intermediary and the second intermediary and not to the client or the server; and
forwarding the message to the first intermediary; and
at the first intermediary:
decrypting the message with the intermediary key;
signing the message with a digital signature derived from the second session key;
encrypting the message with the second session key; and
forwarding the message to the server.

38. The method of claim 37, further comprising:
at the first intermediary:
receiving a response message directed to the client from the server;
decrypting the response message with the second session key;
encrypting the response message with the intermediary key; and
forwarding the response message to the second intermediary; and
at the second intermediary:
decrypting the response message with the intermediary key;
encrypting the response message with the first session key; and
forwarding the response message to the client.

39. A method of establishing a split-terminated authenticated communication connection between a client computing device and a server computing device, the method comprising:
intercepting a request for a first communication connection directed to the server from the client, at a first intermediary situated in a path of communication between the client and the server;
facilitating establishment of the first communication connection by relaying handshaking messages between the server and the client;
after termination of the first communication connection, intercepting a request from the client for a subsequent communication connection with the server;
retrieving authentication credentials of the client from an authentication entity;
forwarding the request for a subsequent communication to the server; and
in response to a rejection received from the server in response to the request for a subsequent communication, using the authentication credentials to authenticate the client to the server;
wherein the rejection is not forwarded to the client.

40. The method of claim 39, wherein the first connection and the subsequent connection are HTTP connections.

41. The method of claim 39, wherein the authentication credentials comprise a Kerberos ticket.

42. The method of claim 39, wherein the authentication credentials comprise a secret key of the client.
